(19) United States
(12) Patent Application Publication
(10) Pub. No.: US 2017/0242522 A1
(43) Pub. Date: Aug. 24, 2017

(54) TOUCH SUBSTRATE AND METHOD FOR MANUFACTURING THE SAME, DRIVING DEVICE AND DRIVING METHOD, TOUCH PANEL AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Changjian XU, Beijing (CN); Junjie LI, Beijing (CN); Guojing MA, Beijing (CN); Shunsha LU, Beijing (CN); Jinyu REN, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/198,178

(22) Filed: Jun. 30, 2016

(30) Foreign Application Priority Data
Feb. 22, 2016 (CN) 201610096547.5

(51) Int. Cl. G06F 3/041; G06F 3/044

(52) U.S. Cl. CPC G06F 3/0416; G06F 3/0412; G06F 3/044; G06F 2203/04103; G06F 2203/04104

(57) ABSTRACT

The present disclosure discloses a touch substrate and a method for manufacturing the same, a driving device and a driving method, a touch panel and a display device. The touch substrate includes a base; and a touch electrode pattern and a wire pattern that are provided on the base, the touch electrode pattern including a plurality of strip-shaped electrodes that are provided in parallel on a same layer, and the wire pattern including a plurality of wires. A first end of each of the strip-shaped electrodes is connected to a wire, and a second end of each of the strip-shaped electrodes is connected to a wire. The first end is provided at an edge of a first side of the touch substrate, and the second end is provided at an edge of a second side opposite to the first side of the touch substrate.

### CROSS-REFERENCE TO RELATED APPLICATION

This application claims a priority to Chinese Patent Application No. 201610096547.5 on Feb. 22, 2016, the disclosure of which is incorporated in its entirety by reference herein.

### TECHNICAL FIELD

The present disclosure relates to the field of the display technology, and particularly to a touch substrate, a method for manufacturing the same, a driving device, a driving method, a touch panel and a display device.

### BACKGROUND

In the technical field of the display technology, a touch screen, as a new input device, has been used more and more widely in the field of the touch display screen. The touch screen products may be divided into four types as follows: an infrared touch screen, a capacitive touch screen, a resistive touch screen and a surface acoustic wave touch screen. Currently, the capacitive touch screen has become a mainstream touch screen technique due to advantages such as a long operating life, high light transmittance and capable of supporting a multi-point touch.

The capacitive touch screen has two types of structures, i.e., a projection capacitive type and a surface capacitive type. The capacitive touch screen has certain advantages compared with other touch screens. However, for the projection capacitive touch screen, regardless of being of a single-layered ITO structure or a double-layered ITO structure, it is needed to scan the x-coordinate and the y-coordinate, so that the touch power consumption is greatly improved. In addition, for most of the single-layered ITO, independent small patterns are employed, so that a relatively high process is required. And for the double-layered ITO, multiple exposures and etchings are required, so the number of processing steps is increased and the productivity is affected. For the surface capacitive touch screen, although there is no need to scan multiple times and its manufacturing process is relatively simple, the multi-point touch cannot be achieved so that the application range is limited.

### SUMMARY

An object of the present disclosure is to provide a touch substrate that performs scanning for a relatively small number of times, has a simple manufacturing process and is able to support a multi-point touch.

In one aspect, in some embodiments, the present disclosure provides a touch substrate, including a base, and a touch electrode pattern and a wire pattern that are provided on the base. The touch electrode pattern includes a plurality of strip-shaped electrodes that are provided in parallel on a same layer, and the wire pattern includes a plurality of wires. A first end of each of the strip-shaped electrodes is connected to a wire, and a second end of each of the strip-shaped electrodes is connected to a wire. The first end is provided at an edge of a first side of the touch substrate, and the second end is provided at an edge of a second side opposite to the first side of the touch substrate.

Alternatively, for each of the strip-shaped electrodes, the wire connected to its first end has the same length as the wire connected to its second end.

Alternatively, each of the strip-shaped electrodes is made of indium tin oxide.

Alternatively, the wire pattern is made of metal.

In another aspect, the present disclosure provides a driving device, for driving the above touch substrate. The driving device includes a first driving module. The first driving module is configured to scan each of the strip-shaped electrodes of the touch substrate to determine the strip-shaped electrode corresponding to a touch point, apply alternating voltages to the two wires connected to both ends of the strip-shaped electrode corresponding to the touch point, and determine a position of the touch point on the strip-shaped electrode corresponding to the touch point according to currents on the two wires.

In yet another aspect, the present disclosure provides a driving device, for driving the touch substrate. The driving device includes a second driving module. The second driving module is configured to apply the alternating voltages to the wires connected to both ends of each of the strip-shaped electrodes of the touch substrate and determine a position of a strip-shaped electrode corresponding to a touch point and a position of the touch point on the strip-shaped electrode corresponding to the touch point according to the currents on the wires.

In still another aspect, in some embodiments, the present disclosure provides a driving method for performing touch detection on the touch substrate. The method includes scanning each of the strip-shaped electrodes of the touch substrate to determine the strip-shaped electrode corresponding to the touch point, applying the alternating voltages to the wires connected to both ends of the strip-shaped electrode corresponding to the touch point, and determining a position of the touch point on the strip-shaped electrode corresponding to the touch point according to currents on the two wires.

In still yet another aspect, the present disclosure provides a driving method for performing touch detection on the touch substrate. The method includes applying the alternating voltages to the wires connected to both ends of each of the strip-shaped electrodes of the touch substrate, and determining the position of a strip-shaped electrode corresponding to the touch point and the position of the touch point on the strip-shaped electrode corresponding to the touch point according to the currents on the wires.

In still yet another aspect, the present disclosure provides a method of manufacturing a touch substrate. The method includes forming the touch electrode pattern and the wire pattern on the base, the touch electrode pattern including a plurality of strip-shaped electrodes that are provided in parallel on the same layer, and the wire pattern including a plurality of wires. The first end of each of the strip-shaped electrodes is connected to a wire, and the second end of each of the strip-shaped electrodes is connected to a wire. The first end is provided at an edge of the first side of the touch substrate, and the second end is provided at an edge of the second side opposite to the first side of the touch substrate.

In still yet another aspect, in some embodiments, the present disclosure provides a touch panel, which includes the above touch substrate.

Alternatively, the touch panel further includes protective glass provided on the touch substrate.

Alternatively, the touch panel further includes adhesive glue between the protective glass and the touch substrate.

In still yet another aspect, in some embodiments, the present disclosure provides a display device, which includes the above touch panel.

The present disclosure provides a touch substrate, wherein the plurality of strip-shaped electrodes that are parallel to each other on the same layer is provided on the base, and wires are provided at both ends of the strip-shaped electrodes. When the touch substrate is driven, it only needs to scan the strip-shaped electrodes or detect currents on wires at both ends of the strip-shaped electrodes, in a column direction, so as to determine the strip-shaped electrode corresponding to the touch point, and then the coordinates corresponding to the touch point can be obtained according to the currents and distances between the touch point and both ends of the strip-shaped electrode. Therefore, the scanning times and the driving power consumption can be effectively reduced. Meanwhile, the touch substrate of the present disclosure can support the multi-point touch. In addition, in the touch substrate of the present disclosure, the plurality of strip-shaped electrodes is provided on the same layer, which facilitates reducing the process difficulty.

### BRIEF DESCRIPTION OF THE DRAWINGS

By reading the following detailed description of the embodiments, various advantages and benefits will be more apparent and clear for a person skilled in the art. The figures are only used to illustrate embodiments, and should not be considered to limit the scope of the present disclosure. In the whole drawings, the same reference signals are used to represent the same component. In the figures,

FIG. 1 is a schematic view showing a single-layered ITO structure;

FIG. 2 is a schematic view showing a double-layered ITO structure;

FIG. 3 is a schematic view showing a touch substrate according to an embodiment of the present disclosure; and

FIG. 4 is a schematic view showing a touch panel according to an embodiment of the present disclosure.

### DETAILED DESCRIPTION

In order to illustrate the object, the features and the advantages of the present disclosure in a clearer manner, the present disclosure will be described hereinafter in detail in conjunction with the drawings and the embodiments. It should be noted that, in the case of no conflicts, the embodiments and the features in the embodiments of the present disclosure can be mutually combined.

A plurality of details is included in the following descriptions so as to facilitate fully understanding the present disclosure. However, the present disclosure may be implemented in other manners that are different from the manners described herein. Therefore, the scope of the present disclosure is not limited by the following disclosed embodiments.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

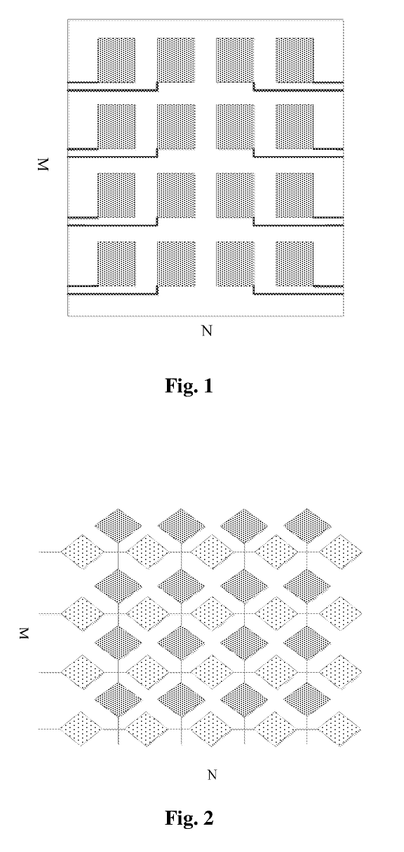

As mentioned above, the capacitive touch screen has two structures: the projected capacitive type and a surface capacitive type. The projected capacitive touch screen can be divided into a self capacitive type and a mutual capacitive type. The corresponding ITO patterns mainly include the single-layered ITO shown in FIG. 1 and the double-layered ITO shown in FIG. 2. The touch detection principles of the single-layered ITO and the double-layered ITO are substantially similar. When a user's finger touches a screen, the capacitance at a touch position is changed due to the electric field of a human body. After scanning the x-coordinate and the y-coordinate, a sensing chip may determine a position where the capacitance is changed so as to obtain a position of the touch point. The surface capacitive touch screen may employ the single-layered ITO pattern. When the finger touches the touch screen, a part of charges are transferred to the human body. For recovering a loss of the charges, the charges are supplemented from four corners of the screen. The supplemented charge quantities are in direct proportion to distances between the touch point and the corners. Hence, the position of the touch point is calculated.

The capacitive touch screen has advantages compared with other touch screens. However, for the projected capacitive touch screen, regardless of being of a single-layered ITO or a double-layered ITO structure, it is needed to scan the x-coordinate and the y-coordinate. As shown in FIGS. 1 and 2, the single-layered ITO needs to be scanned for M*N times, and the double-layered ITO needs to be scanned for M+N times. Scanning for multiple times greatly improves the touch power consumption. In addition, for most of the single-layered ITO, independent small patterns are employed so that a relatively high process is required, and for the double-layered ITO, multiple exposures and etchings are required, so the number of processing steps is increased and the productivity is affected. For the surface capacitive touch screen, although there is no need to scan multiple times and its process is relatively simple, the multi-point touch cannot be achieved so that the application range is limited.

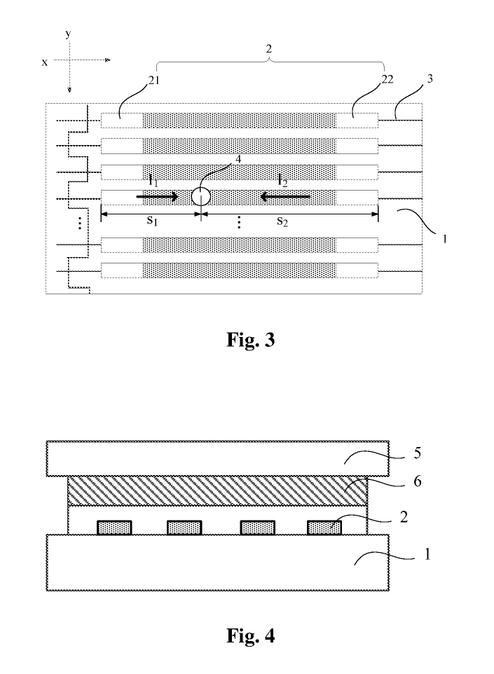

In view of that, in one aspect, the present disclosure provides a touch substrate. As shown in FIG. 3, it includes a base 1 and a touch electrode pattern and a wire pattern that are provided on the base 1. The touch electrode pattern includes a plurality of strip-shaped electrodes 2 that are provided in parallel on the same layer, and the wire pattern includes a plurality of wires 3. For each of the strip-shaped electrodes 2, a first end 21 of each of the strip-shaped electrodes is connected to a wire 3, and a second end 22 of each of the strip-shaped electrodes is connected to a wire 3. Besides, the first end 21 is provided at an edge of a first side of the touch substrate, and the second end 22 is provided at an edge of a second side opposite to the first side of the touch substrate.

According to the touch substrate of the present disclosure, the plurality of strip-shaped electrodes that are parallel to each other on the same layer is provided on the base, and wires are provided at both ends of the strip-shaped electrodes. When the touch substrate is driven, it only needs to scan the strip-shaped electrodes or detect currents on wires at both ends of the strip-shaped electrode, in a column direction (i.e. the y direction in FIG. 3) so as to determine the strip-shaped electrode corresponding to the touch point and then the coordinates corresponding to the touch point are obtained according to the currents and distances between the touch point and both ends of the strip-shaped electrode. Therefore, the scanning times and the driving power consumption can be effectively reduced. Meanwhile, the touch substrate of the present disclosure can support the multi-point touch. In addition, in the touch substrate of the present disclosure, the plurality of strip-shaped electrodes is provided on the same layer, which facilitates reducing the process difficulty.

The touch substrate in FIG. 3 may be driven in multiple methods. Some driving methods provided by the present disclosure are explained hereinafter in conjunction with the drawings of the present disclosure.

The first driving method may specifically include step S11 and step S12.

Step S11: scanning each of the strip-shaped electrodes in the touch substrate to determine the strip-shaped electrode corresponding to a touch point.

Specifically, as shown in FIG. 3, the strip-shaped electrodes 2 may be scanned one by one in the y direction shown in FIG. 3 by a square wave. When touches do not occur, the capacitance on each of the strip-shaped electrodes is not changed. When touches occur, a coupling capacitor will be formed between the strip-shaped electrode 2 corresponding to a touch point 4 and the finger of the user, which causes the capacitance at the touch point 4 to be changed. The strip-shaped electrode 2 corresponding to the touch point 4 then can be determined according to the changes of the capacitance. Then, the coordinates of the touch point 4 in the y direction can be obtained according to the position of the strip-shaped electrode 2 on the touch substrate.

Step S12: applying alternating voltages to the two wires connected to both ends of the strip-shaped electrode corresponding to the touch point, and determining a position of the touch point on the strip-shaped electrode according to the currents on the two wires.

Specifically, after the strip-shaped electrode corresponding to the touch point 4 is determined, the alternating voltages are applied to two wires 3 connected to the first end 21 and the second end 22 of the strip-shaped electrode 2. For example, two electrodes may be provided to be connected to wires 3 at both ends respectively, and the two electrodes are used to apply the alternating voltages to the wires 3 at both ends. As shown in FIG. 3, since a coupling capacitance is present at the touch point 4 of the strip-shaped electrode 2, the currents will flow to the touch point 4 from both ends of the strip-shaped electrode in the direction shown by the arrow in FIG. 3. At this time, the size of the current flowing from both ends to the touch point 4 has a certain proportion relation with a distance between the touch point 4 and both ends of the strip-shaped electrode 2. The specific position of the touch point 4 on the strip-shaped electrode 2 can be obtained according to the proportion relation. That is, the specific position of the touch point 4 on the strip-shaped electrode 2 can be obtained according to proportion relations among a current I₁ on the wire 3 of the first end 21, a current I₂ on the current 3 of the second end 22, a distance S₁ between the touch point 4 and the first end 21, and a distance S₂ between the touch point 4 and the second end 22 in FIG. 3 so as to obtain the coordinates of the touch point 4 in the x direction. Then, the coordinate in the x direction and the coordinate in the y direction are sent to a processor (e.g., Central Processing Unit CPU).

By means of the driving method, when the touch substrate is driven, the strip-shaped electrode corresponding to the touch point can be determined to obtain the coordinates of the touch point in the y direction only by scanning the strip-shaped electrodes 2 one by one in the y direction. Then, the coordinates of the touch point in the x direction can be obtained according to the proportion relation. Therefore, there is no need to perform scanning in the x direction, which effectively reduces the scanning times of touch detection, and reduces the driving power consumption.

Although only one touch point is shown in FIG. 3, it can be easily understood that, during actual practice, there can be a plurality of touch points. At this time, in the above step S11, the touch electrode corresponding to each touch point can be determined according to changes of the corresponding coupling capacitance. Next, in step S12, corresponding alternating voltages may be applied to each of the determined touch electrodes, and the specific position (i.e. the position in the x direction) of each touch point on the touch electrode can be determined according to the changes of the currents on two wires corresponding to each of the touch electrodes.

During specific implementation, the driving method here can be realized by means of the corresponding driving device. Specifically, a driving module can be provided in the corresponding driving device (for facilitating the differentiation, the driving module here is referred to as a first driving module). The first driving module is configured to scan each of the strip-shaped electrodes in the touch substrate to determine the strip-shaped electrode corresponding to the touch point, and apply the alternating voltages to the two wires connected to both ends of the strip-shaped electrode corresponding to the touch point, and determine the position of the touch point on the strip-shaped electrode according to the currents on the two wires.

During specific implementation, the driving device here may refer to a touch driver integrated circuit (Touch Driver IC).

The second driving method may specifically include Step S21 and Step S22.

Step S21: applying the alternating voltages to the wires connected to both ends of each of the strip-shaped electrode in the touch substrate, and determining the strip-shaped electrode corresponding to the touch point according to the currents on the wires.

Specifically, as shown in FIG. 3, the alternating voltages are applied to the wires 3 connected to both ends of each of the strip-shaped electrodes 2 in the touch substrate. When touches do not occur, the current on each of the strip-shaped electrodes 2 is not changed. When touches occur, a coupling capacitor will be formed between the strip-shaped electrode 2 corresponding to the touch point 4 and the user, which causes the capacitance at the touch point 4 to be changed so that the current on the strip-shaped electrode 2 corresponding to the touch point 4 is changed, whereas the currents on other strip-shaped electrodes 2 are not changed. Therefore, the position of the strip-shaped electrode 2 corresponding to the touch point 4 can be determined so as to determine the coordinates of the touch point 4 in the y direction.

Step S22: determining the position of the touch point on the strip-shaped electrode according to the currents on the wire.

Specifically, as shown in FIG. 3, after the coordinate of the touch point 4 in the y direction is determined, the specific position of the touch point 4 on the strip-shaped electrode 2 is obtained according to a proportion relation between the sizes of the currents flowing from both ends of the strip-shaped electrode 2 to the touch point 4 and the distance between the touch point 4 and both ends of the strip-shaped electrodes 2, so as to obtain the coordinates of the touch point 4 in the x direction. The specific process of determining the coordinates in the x direction can refer to the description in the first driving method, and will be omitted here.

After the coordinate in the x direction and the coordinate in the y direction are determined, they may be sent to the processor (e.g., CPU).

When the second driving method is used to drive the touch substrate shown in FIG. 3, the alternating voltages are applied to the strip-shaped electrode 2 and the strip-shaped electrode 2 corresponding to the touch point is determined according to the changes of the currents upon the occurrences of the touch, so that the coordinates of the touch point in the y direction can be obtained. Then, the coordinates of the touch point 4 in the x direction can be obtained according to the proportion relation. Therefore, there is no need to perform scanning with the square wave, or to perform scanning in both x and y directions, and thus, the driving power consumption is effectively reduced.

It also can be easily understood that, a multi-point detection can be realized in the second driving method. Specifically, when there is a plurality of touch points, in step S22, the currents on the wires connected to the touch electrodes corresponding to each touch point will be different from the currents when no touches occur. The positions of the touch points on the touch electrode can be determined according to the proportion relation of the currents on the two wires connected to the touch electrodes. The position of each touch point can be determined by the above manner.

The second driving method can be realized with the corresponding driving device. For example, a second driving module is provided in the corresponding driving device. The second driving module is configured to apply the alternating voltages to the wires connected to both ends of each of the strip-shaped electrodes in the touch substrate and determine the position of the strip-shaped electrode corresponding to the touch point and the position of the touch point on the strip-shaped electrode according to the currents on the wires.

During specific implementation, as shown in FIG. 3, the wire 3 connected to the first end 21 of the strip-shaped electrode 2 on the touch substrate may have the same length as the wire 3 connected to the second end 22. It can be easily understood that, the wires 3 at both ends have the same length, and thus, when the coordinates of the touch position in the x direction are obtained by the two driving methods, the sizes of the currents flowing from both ends to the touch point is in direct proportion to the distances between the touch point and both ends of the strip-shaped electrode 2. At this time, the coordinates of the touch point in the x direction can be obtained by the following formula (I).

$$\frac{{I}_{1}}{{I}_{2}} = \frac{{s}_{1}}{{s}_{2}} \qquad ( I )$$

As can be seen, when the wires at both ends are set to have an identical length, it is able to easily obtain the coordinates in the x direction for the above two driving methods when determining the position of the touch point, so that the touch detection efficiency can be effectively improved.

During specific implementation, the material of each strip-shaped electrode in the touch electrode pattern on the touch substrate shown in FIG. 3 can be indium tin oxide (ITO), or other transparent conducting materials such as alumina zinc oxide or indium zinc oxide. The material of the wires in the wire pattern can be metal.

In another aspect, the present disclosure further provides a method of manufacturing a touch substrate, which can be used to manufacture the touch substrate shown in FIG. 3. The method specifically includes forming the touch electrode pattern and the wire pattern on the base, the touch electrode pattern including a plurality of strip-shaped electrodes that are provided in parallel on the same layer, and the wire pattern including a plurality of wires. The first end of each of the strip-shaped electrodes is connected to a wire, and the second end of each of the strip-shaped electrodes is connected to a wire. The first end is provided at an edge of a first side of the touch substrate, and the second end is provided at an edge of a second side opposite to the first side of the touch substrate.

According to the method of manufacturing the touch substrate of the present disclosure, only one layer of the touch electrode pattern and the wire pattern are formed on the substrate. Compared with the double-layered ITO structure in the related arts, in the method of the present disclosure, multiple exposures and etchings are not required. Thus, the processing steps and the process costs are reduced. In addition, the touch electrode pattern only includes a plurality of strip-shaped electrodes. Compared with the single-layered ITO structure in the arts, in which a plurality of independent small patterns needs to be formed, in the present disclosure, the process requirements and the process difficulty are reduced, and the productivity are further improved.

In yet another aspect, the present disclosure provides a touch panel. Referring to FIG. 4, the touch panel includes a touch substrate and protective glass 5 provided on the touch substrate. Adhesive glue 6 is provided between the protective glass 5 and the touch substrate. The touch substrate here may be the touch substrate shown in FIG. 3, and it includes the base 1, and the touch electrode pattern and the wire pattern that are provided on the base. The touch electrode pattern includes a plurality of strip-shaped electrodes 2 that are provided in parallel on the same layer, and the wire pattern includes a plurality of wires. When the capacitive screen is assembled to the display screen, the assembling can be carried out in an on-cell manner. That is, the capacitive screen is arranged between a colored filter substrate and a polarizer of the display screen so as to realize the display function.

In still another aspect, the present disclosure provides a display device, which includes the above touch panel. The process difficulty for manufacturing the display device is relatively low. The display device has relatively low driving power consumption when detecting the touch point, and can support the multi-point touch. Therefore, it has a relatively wide application range.

During specific implementation, the display device here may be a product or a component that has a display function such as an e-book, a mobile phone, a tablet computer, a television, a display, a notebook computer, a digital photo frame, a navigator and the like.

The above are merely the preferred embodiments of the present disclosure and shall not be used to limit the scope of the present disclosure. It should be noted that, a person skilled in the art may make improvements and modifications without departing from the principle of the present disclosure, and these improvements and modifications shall also fall within the scope of the present disclosure.

What is claimed is:

1. A touch substrate, comprising:
a base; and
a touch electrode pattern and a wire pattern that are provided on the base, the touch electrode pattern comprising a plurality of strip-shaped electrodes that are provided in parallel on a same layer, and the wire pattern comprising a plurality of wires,
wherein a first end of each of the strip-shaped electrodes is connected to a wire, and a second end of each of the strip-shaped electrodes is connected to a wire, and
the first end is provided at an edge of a first side of the touch substrate, and the second end is provided at an edge of a second side opposite to the first side of the touch substrate.

2. The touch substrate according to claim 1, wherein for each of the strip-shaped electrodes, the wire connected to its first end has the same length as the wire connected to its second end.

3. The touch substrate according to claim 1, wherein each of the strip-shaped electrodes is made of indium tin oxide.

4. The touch substrate according to claim 1, wherein the wire pattern is made of metal.

5. A driving device, for driving the touch substrate according to claim 1, comprising a first driving module, wherein
the first driving module is configured to scan each of the strip-shaped electrodes of the touch substrate to determine the strip-shaped electrode corresponding to a touch point, apply alternating voltages to the two wires connected to both ends of the strip-shaped electrode corresponding to the touch point, and determine a position of the touch point on the strip-shaped electrode corresponding to the touch point according to currents on the two wires.

6. A driving device, for driving the touch substrate according to claim 1, comprising a second driving module, wherein
the second driving module is configured to apply alternating voltages to the wires connected to both ends of each of the strip-shaped electrodes of the touch substrate and determine a position of a strip-shaped electrode corresponding to a touch point and a position of the touch point on the strip-shaped electrode corresponding to the touch point according to currents on the wires.

7. A driving method, for performing touch detection on the touch substrate according to claim 1, comprising
scanning each of the strip-shaped electrodes of the touch substrate to determine the strip-shaped electrode corresponding to a touch point,
applying alternating voltages to the wires connected to both ends of the strip-shaped electrode corresponding to the touch point, and
determining a position of the touch point on the strip-shaped electrode corresponding to the touch point according to currents on the two wires.

8. A driving method, for performing touch detection on the touch substrate according to claim 1, comprising
applying alternating voltages to the wires connected to both ends of each of the strip-shaped electrodes of the touch substrate, and
determining a position of a strip-shaped electrode corresponding to a touch point and a position of the touch point on the strip-shaped electrode corresponding to the touch point according to currents on the wires.

9. A method of manufacturing a touch substrate, comprising
forming a touch electrode pattern and a wire pattern on a base, the touch electrode pattern comprising a plurality of strip-shaped electrodes that are provided in parallel on the same layer, and the wire pattern comprising a plurality of wires,
wherein a first end of each of the strip-shaped electrodes is connected to a wire, and a second end of each of the strip-shaped electrodes is connected to a wire, and
the first end is provided at an edge of a first side of the touch substrate, and the second end is provided at an edge of a second side opposite to the first side of the touch substrate.

10. A touch panel, comprising the touch substrate according to claim 1.

11. The touch panel according to claim 10, further comprising protective glass on the touch substrate.

12. The touch panel according to claim 11, further comprising adhesive glue between the protective glass and the touch substrate.

13. The touch panel according to claim 10, wherein for each of the strip-shaped electrodes, the wire connected to its first end has the same length as the wire connected to its second end.

14. The touch panel according to claim 10, wherein each of the strip-shaped electrodes is made of indium tin oxide.

15. The touch panel according to claim 10, wherein the wire pattern is made of metal.

16. A display device, comprising the touch panel according to claim 10.

17. The display device according to claim 16, wherein the touch panel further comprises protective glass on the touch substrate and adhesive glue between the protective glass and the touch substrate.

18. The display device according to claim 16, wherein for each of the strip-shaped electrodes, the wire connected to its first end has the same length as the wire connected to its second end.

19. The display device according to claim 16, wherein each of the strip-shaped electrodes is made of indium tin oxide.

20. The display device according to claim 16, wherein the wire pattern is made of metal.
